(19) United States
(12) Patent Application Publication
(10) Pub. No.: US 2015/0052981 A1
(43) Pub. Date: Feb. 26, 2015

(54) APPARATUS AND METHOD FOR MEASURING THE VISCOSITY OF A FLUID USING ULTRASONIC WAVES

(71) Applicant: Soongsil University Research Consortium Techno-Park, Seoul (KR)

(72) Inventors: Jin Oh Kim, Seoul (KR); Chunguang Piao, Seoul (KR)

(73) Assignee: Soongsil University Research Consortium Techno-Park, Seoul (KR)

(21) Appl. No.: 14/134,252

(22) Filed: Dec. 19, 2013

(30) Foreign Application Priority Data
Aug. 26, 2013 (KR) 10-2013-0101011

(51) Int. Cl. G01N 11/00; G01N 29/024

(52) U.S. Cl. CPC G01N 11/00; G01N 29/024
USPC 73/54.41

(57) ABSTRACT

A method for measuring an ultrasonic viscosity includes applying a driving voltage to a plurality of first piezoelectric transducers provided along an outer wall circumference of a pipe at constant intervals to generate a torsional wave on a surface of the pipe, receiving the torsional wave propagated along the surface of the pipe through a plurality of second piezoelectric transducers provided along the outer wall circumference of the pipe at constant intervals while being spaced from the first piezoelectric transducers at a certain distance in a longitudinal direction of the pipe to convert the torsional wave into a voltage signal, calculating an attenuation and a propagation velocity of the torsional wave based on the time for the propagation of the torsional wave and the converted voltage signal, and measuring viscosity of the fluid in the pipe based on the calculated attenuation and propagation velocity of the torsional wave.

### CROSS-REFERENCE TO RELATED APPLICATION

This application claims the benefit of Korean Patent Application No. 10-2013-0101011 filed on Aug. 26, 2013, the entire disclosures of which are incorporated herein by reference.

### FIELD OF THE INVENTION

The present disclosure relates to an apparatus and a method for measuring viscosity of a fluid in a pipe by using ultrasonic waves.

### BACKGROUND OF THE INVENTION

Viscosity measurement measures viscosity of liquid and gas (i.e., a fluid). Especially, liquid viscosity measurement is generally utilized for the purpose of determining unique viscosity of high molecular liquid.

Conventionally, in order to measure viscosity of liquid, there has been widely used the Ostwald viscosity measurement method, by which a certain amount of a sample flows down through a short and slim tube naturally under the gravity from an upper liquid flow to a lower liquid flow. There has been also used the Ubbelohde viscosity measurement method, which uses the same principle as used for the Ostwald viscosity measurement and can measure various concentrations of a solution by adding solvents to a large lower liquid flow in a different form to dilute the initially added solution. However, these viscosity measurement methods are not suitable for viscosity measurement of fluids such as high molecular weight aqueous solutions since they cannot reduce the flow velocity of fluids.

With respect to fluid viscosity measurement methods other than the above-described methods, there are a spin viscosity measurement method, which measures viscosity of a fluid by measuring torques generated when a viscous fluid is injected between concentric cylinders being spaced with a small interval, and the inner cylinder spins, and others.

Meanwhile, the foregoing viscosity measurement methods include complicated viscosity measurement processes, which should separately move part (e.g., a sample) of a fluid into viscosity measurement means and directly contact and treat the fluid. Further, the methods have a limit in measuring viscosity of a fluid in real time when the fluid has filled a certain container or is flowing therein, like an oil supply line. In addition, an environment of viscosity measurement means may be different from an original environment of a fluid, and thereby, resulting in low accuracy and reliability of viscosity measurement results.

In order to resolve these problems, there has been recent development of a viscosity measurement method capable of measuring viscosity in an original environment, under which a fluid exists, by using ultrasonic waves without directly contacting a fluid.

In this regard, Korean Patent No. 10-0602227 (Title of Invention: Apparatus and Method for Measurement of Fluid Viscosity in Container) describes an apparatus and a method for viscosity measurement, which includes: a transmission mechanism that contacts a container or a pipe to transmit a signal to the inside of an unknown fluid in the container or the pipe and provides a signal to the fluid in the container or the pipe; a reception mechanism that contacts the container or the pipe to receive the signal decreased after passing through the unknown fluid and receives the signal from the fluid in the container or the pipe; and a determination mechanism that determines viscosity of the unknown fluid in the container or the pipe directly from the signal decreased after passing through the fluid and is connected to the reception mechanism.

However, in the conventional viscosity measurement method using ultrasonic waves, each of ultrasonic wave transmission and reception mechanisms is fabricated to fit to the appearance of the certain container (or the pipe) or be in the form directly attached onto the container. As such, the shape and the size of the container that can measure viscosity are restricted. Further, the corresponding viscosity measurement apparatus cannot be applied to or provided in a different container. In addition, there has been a limit in that as the ultrasonic signal generated in the transmission mechanism passes through the wall of the container and the fluid therein to be propagated and received in the reception mechanism, the fluid state (e.g., ‘inconstant flow velocity’ and ‘foam included’) in the container may affect the viscosity measurement results.

### BRIEF SUMMARY OF THE INVENTION

In order to solve the foregoing conventional technical problems, an illustrative embodiment of the present disclosure provides an apparatus and a method for measuring viscosity of a fluid in a container by using torsional waves of ultrasonic signals.

The technical problems, which are sought to be solved by the illustrative embodiment of the present disclosure, are not limited to those described above. There may be other technical problems, which are sought to be solved by the illustrative embodiment of the present disclosure.

In accordance with an aspect of illustrative embodiments, there is provided an ultrasonic viscosity measuring apparatus for measuring viscosity of a fluid in a pipe. The apparatus includes an ultrasonic wave transmission unit, in which when a preset voltage signal is applied, the voltage signal is converted into an ultrasonic signal to be propagated to a surface of the pipe; an ultrasonic wave reception unit, in which the ultrasonic signal propagated through the surface of the pipe is received and converted into a voltage signal; and a viscosity measurement unit, in which viscosity of the fluid in the pipe is measured based on the voltage signal converted by the ultrasonic wave reception unit, wherein the ultrasonic wave transmission unit and the ultrasonic wave reception unit are provided on an outer wall of the pipe while being spaced from each other at a certain distance in a longitudinal direction of the pipe, and the ultrasonic signal is a torsional wave.

Further, in accordance with another aspect of the illustrative embodiments, there is provided an ultrasonic viscosity measuring method for measuring viscosity of a fluid in a pipe through an ultrasonic viscosity measuring apparatus. The method includes (a) applying a driving voltage to a plurality of first piezoelectric transducers provided along an outer wall circumference of the pipe at constant intervals to generate a torsional wave on a surface of the pipe; (b) receiving the torsional wave propagated along the surface of the pipe through a plurality of second piezoelectric transducers provided along the outer wall circumference of the pipe at constant intervals while being spaced from the first piezoelectric transducers at a certain distance in a longitudinal direction of the pipe to convert the torsional wave into a voltage signal; (c) calculating an attenuation and a propagation velocity of the torsional wave based on the time for the propagation of the torsional wave and the converted voltage signal; and (d) measuring viscosity of the fluid in the pipe based on the calculated attenuation and propagation velocity of the torsional wave.

According to one of the foregoing means to solve the technical problems, it is possible to measure fluid viscosity within a pipe, by using a torsional wave as an ultrasonic signal for viscosity measurement, based on an ultrasonic signal propagated on a surface of the pipe. That is, there is an effect in obtaining accurate and highly reliable viscosity measurement results, regardless of the state of the fluid within the pipe.

According to one of the foregoing means to solve the technical problems, there is an effect in providing a viscosity measurement apparatus without regard to a diameter (i.e., a size) and a shape of a pipe containing a fluid therein, by installing multiple piezoelectric transducers for processing an ultrasonic signal to surround on the pipe by using jigs and wires.

According to one of the foregoing means to solve the technical problems, convenience can be provided since it is possible to measure viscosity of a fluid in real time in the state that the fluid is flowing in the pipe or has filled the pipe without performing separate processes such as taking a sample.

### BRIEF DESCRIPTION OF THE DRAWINGS

Non-limiting and non-exhaustive embodiments of the present disclosure will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a block diagram showing configuration of an ultrasonic viscosity measuring apparatus in accordance with an illustrative embodiment of the present disclosure;

FIG. 2 is a block diagram for depiction of a method for transmitting and receiving ultrasonic waves through the ultrasonic viscosity measuring apparatus in accordance with an illustrative embodiment of the present disclosure;

FIG. 3 depicts configuration of an ultrasonic wave transmission unit and an ultrasonic wave reception unit in accordance with an illustrative embodiment of the present disclosure;

FIG. 4 depicts a method for fixing piezoelectric transducers to jigs in accordance with an illustrative embodiment of the present disclosure; and

FIG. 5 is a sequence view for depiction of an ultrasonic viscosity measuring method in accordance with an illustrative embodiment of the present disclosure;

### DETAILED DESCRIPTION OF THE INVENTION

Hereinafter, illustrative embodiments of the present disclosure will be described in detail with reference to the accompanying drawings so that inventive concept may be readily implemented by those skilled in the art. However, it is to be noted that the present disclosure is not limited to the illustrative embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. Further, the term “comprises or includes” and/or “comprising or including” used in the document means that one or more other components, steps, operations, and/or the existence or addition of elements are not excluded in addition to the described components, steps, operations and/or elements.

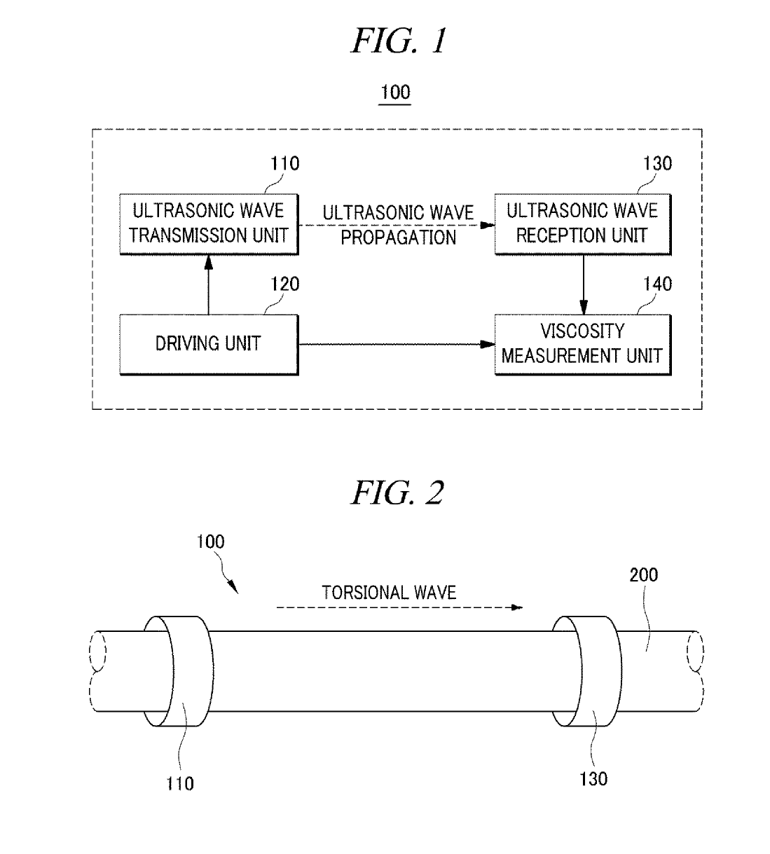

FIG. 1 is a block diagram showing configuration of an ultrasonic viscosity measuring apparatus in accordance with an illustrative embodiment of the present disclosure. FIG. 2 depicts a method for transmitting and receiving ultrasonic waves through the ultrasonic viscosity measuring apparatus in accordance with an illustrative embodiment of the present disclosure.

An ultrasonic viscosity measuring apparatus 100 in accordance with an illustrative embodiment of the present disclosure is provided outside a container capable of containing a fluid to measure viscosity of the fluid that has filled the container or is flowing therein. In the illustrative embodiment of the present disclosure, the container having a space capable of containing a fluid is collectively referred to as a pipe.

As shown in FIG. 1, the ultrasonic viscosity measuring apparatus 100 includes an ultrasonic wave transmission unit 110, a driving unit 120, an ultrasonic wave reception unit 130 and a viscosity measurement unit 140.

In this case, as illustrated in FIG. 2, each of the ultrasonic wave transmission unit 110 and the ultrasonic wave reception unit 130 is provided in the form surrounding an outer wall of a pipe 200, while being spaced from each other in the longitudinal direction of the pipe 200 with a certain distance.

The ultrasonic wave transmission unit 110 is provided on the outer wall of the pipe to convert an applied voltage signal into an ultrasonic signal and propagate the signal to the surface of the pipe. In this case, the ultrasonic wave transmission unit 110 includes multiple piezoelectric transducers, which convert an applied voltage signal into a torsional wave.

For reference, as illustrated in FIG. 2, an ultrasonic signal generated from the ultrasonic wave transmission unit 110 is propagated along the surface of the pipe 200 and transmitted to the ultrasonic wave reception unit 130.

The driving unit 120 applies a preset size and type of a driving voltage to the ultrasonic wave transmission unit 110. In this case, the driving unit 120 applies an AC voltage by the piezoelectric transducers of the ultrasonic wave transmission unit 110 while applying the AC voltage in a direction perpendicular to a polarization direction of each of the piezoelectric transducers.

The ultrasonic wave reception unit 130 receives the ultrasonic signal propagated through the surface of the pipe, and converts the received ultrasonic signal into a voltage signal to output the signal to the viscosity measurement unit 140. In this case, the ultrasonic wave reception unit 130 includes multiple piezoelectric transducers that convert the received ultrasonic signal (i.e., the torsional wave) into a voltage signal.

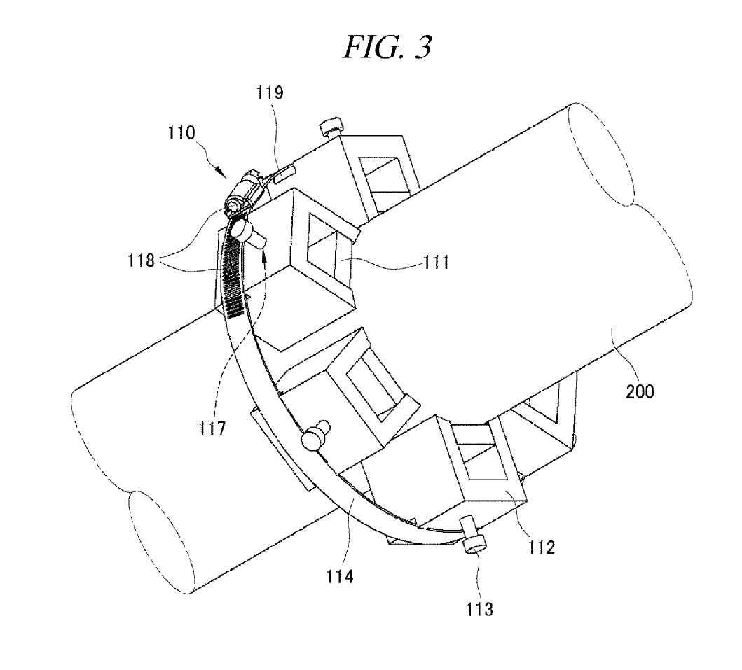

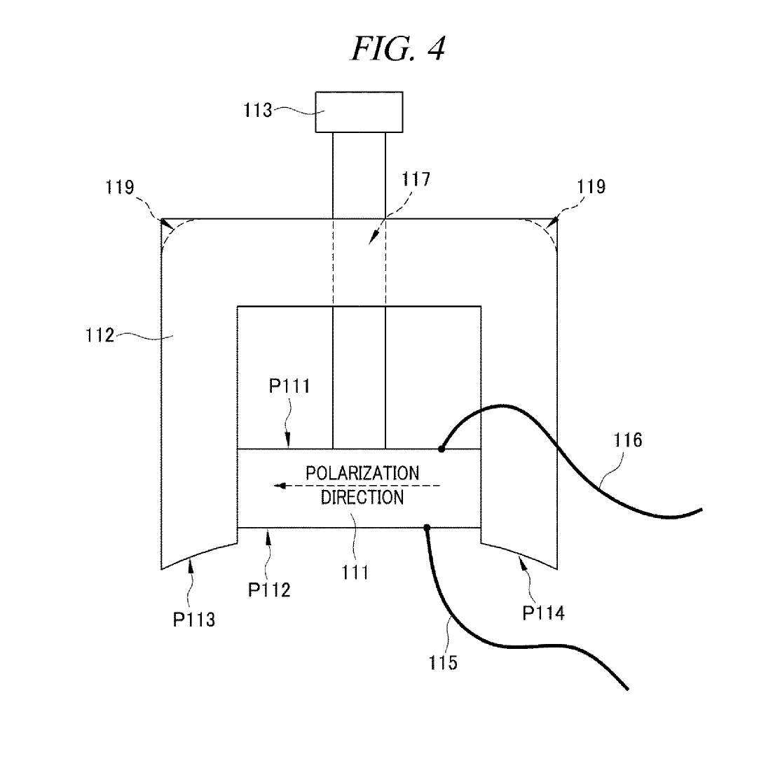

The configuration and the operation of the ultrasonic wave transmission unit 110 and the ultrasonic wave reception unit 130, and the method for providing each of the units on the outer wall of the pipe are described in detail below with reference to FIGS. 3 and 4.

The viscosity measurement unit 140 measures viscosity of the fluid in the pipe based on the voltage signal converted by the ultrasonic wave reception unit 130. In this case, the viscosity measurement unit 140 measures the viscosity of the fluid in the pipe based on the time required for the torsional wave generated from the ultrasonic wave transmission unit 110 to reach the ultrasonic wave reception unit 130, and a voltage value for the voltage signal output from the ultrasonic wave reception unit 130.

Specifically, the viscosity measurement unit 140 calculates attenuation and a propagation velocity of the torsional wave based on the time when the torsional wave is generated, the time when the torsional wave is received, and a voltage value for the voltage signal converted from the ultrasonic signal. For reference, as the viscosity of the fluid in the pipe is high, the resistance to the ultrasonic signal propagated through the surface of the pipe becomes large, and thereby, decreasing the ultrasonic signal. Based on this viscosity characteristic, the viscosity measurement unit 140 measures a fluid viscosity value corresponding to the calculated attenuation and propagation velocity of the torsional wave.

Meanwhile, although FIG. 2 does not separately illustrate the driving unit 120 and the viscosity measurement unit 140 of the ultrasonic viscosity measuring apparatus 100, the driving unit 120 and the viscosity measurement unit 140 may be connected to the ultrasonic wave transmission unit 110 and the ultrasonic wave reception unit 130, respectively, through wires, etc., as described below with reference to FIGS. 3 and 4.

Hereinafter, the configuration and the operation of the ultrasonic wave transmission unit 110 and the ultrasonic wave reception unit 130, and the method for providing the units on the pipe in accordance with an illustrative embodiment of the present disclosure are described in detail below with reference to FIGS. 3 and 4.

FIG. 3 depicts the configuration of the ultrasonic wave transmission unit and the ultrasonic wave reception unit in accordance with an illustrative embodiment of the present disclosure. FIG. 4 depicts a method for fixing the piezoelectric transducers to jigs in accordance with an illustrative embodiment of the present disclosure.

Each of the ultrasonic wave transmission unit 110 and the wave ultrasonic reception unit 130 in accordance with an illustrative embodiment of the present disclosure includes multiple piezoelectric transducers. The multiple piezoelectric transducers are arranged and fixed along the circumstance of the pipe at constant intervals.

Meanwhile, FIGS. 3 and 4 illustrate the configuration of the ultrasonic wave transmission unit 110. However, the ultrasonic wave transmission unit 110 and the ultrasonic wave reception unit 130 in accordance with an illustrative embodiment of the present disclosure are different from each other only in terms of the piezoelectric characteristic of the piezoelectric transducers and identical to each other in terms of configuration, a shape and a providing method thereof on a pipe. Thus, the ultrasonic wave reception unit 130 is described together with reference to FIGS. 3 and 4.

Specifically, as shown in FIG. 3, the ultrasonic wave transmission unit 110 includes multiple piezoelectric transducers 111, multiple jigs 112, multiple screws 113, and a wire 114. For reference, the ultrasonic wave reception unit 130 also includes multiple piezoelectric transducers, multiple jigs, multiple screws, and a wire.

When a voltage signal is applied, the piezoelectric transducers 111 convert the voltage signal into a torsional wave. The piezoelectric transducers 111 are configured by a piezoelectric element polarized in the circumferential direction of the pipe 200. In this case, when a driving voltage (i.e., an AC voltage) is applied in a direction perpendicular to the polarization direction of the piezoelectric element, a torsional wave is generated by shear movement within the piezoelectric element.

Specifically, as shown in FIG. 4, cables 115, 116 are connected to a top surface P111 and a bottom surface P112 of the piezoelectric transducers 111 in the thickness direction thereof, respectively. The driving voltage applied by the driving unit 120 is applied to the piezoelectric transducers 111 through the cables 115, 116. For reference, the bottom surface P112 of the piezoelectric transducers 111 means a surface thereof in contact with the outer wall of the pipe 200. That is, as illustrated in FIG. 3, the piezoelectric transducers 111 are provided on the pipe 200, such that the bottom surface P112 of the piezoelectric transducers 111 contacts the outer wall surface of the pipe 200.

The jigs 112 are configured to correspond to the piezoelectric transducers 111, respectively, and have a shape allowing at least part of the piezoelectric transducers 111 to be inserted thereinto. For example, as shown in FIG. 4, the jigs 112 may be of a hexahedral shape, and at least one side of the hexahedron is open in a size allowing the insertion of the piezoelectric transducers.

Of the multiple sides of the jigs 112, the side facing to the open side has a screw hole 117, through which a screw 113 passes for engagement.

The screw 113 is configured to apply a pressure to the piezoelectric transducers 111 in the direction of the pipe 200, such that the piezoelectric transducers 111 inserted into and fixed to the jigs 112 closely contact the outer wall surface of the pipe 200.

Specifically, the screw 113 passes through the jigs 112 via the screw hole 117 formed on the jigs 112 so as to contact one surface of the piezoelectric transducers 111 fixed to the jigs 112. In this case, when a pressure is applied to one surface (i.e., the top surface P111 in FIG. 4) of the piezoelectric transducers 111 through the screw 113 in the direction toward the pipe 200 in the state that the jigs 112, to which the piezoelectric transducers 111 are fixed, are arranged and fixed on the outer wall of the pipe 200, the other surface (i.e., the bottom surface P112 in FIG. 4) of the piezoelectric transducers 111 closely contacts the outer wall surface of the pipe 200.

The wire 114 surrounds the multiple jigs 112 arranged along the outer wall circumstance of the pipe 200 at constant intervals to fix the jigs 112 onto the outer wall of the pipe 200.

In this case, the wire 114 is fastened in the state that the piezoelectric transducers 111 fixed to the jigs 112 are sufficiently tightened so as to contact the outer wall surface of the pipe 200. Specifically, both ends of the wire 114 are configured with mutually corresponding wire fastening units 118 for the fastening process. For example, the wire fastening units 118 at both the ends of the wire 114 can be connected to each other in the manner that they are hooked with or engaged into each other. The wire fastening units 118 can be configured in a multiple fastening form for setting various fastening positions in the longitudinal direction of the wire 114.

Meanwhile, as shown in FIGS. 3 and 4, the jigs 112 may have guide grooves 119 for guiding the wire 114. In this case, the guide grooves 119 are engraved in a size and a shape allowing the wire 114 to be inserted thereinto on external parts of one side (i.e., the side facing to the open side) of the jigs 112. For example, the guide grooves 119 may be engraved across the above-described side of the jigs 112, or as illustrated in FIG. 4, on both edges of one side of the jigs 112. In addition, FIG. 4 illustrates the guide grooves 119, which are engraved in a curved surface form corresponding to the shape (i.e., circle) of the pipe 200. Accordingly, the wire 114 can tightly surround the multiple jigs 112 arranged along the circumstance of the pipe 200.

Meanwhile, as shown in FIG. 4, both ends P113, P114 of the open side (i.e., the side, into which the piezoelectric transducers 111 are inserted, of the jigs 112 may be in a curved surface form corresponding to the shape of the pipe 200. Accordingly, the jigs 112 can be closely and stably fixed along the outer wall of the pipe 200.

A method for providing the ultrasonic wave transmission unit 110 configured as described above on the pipe 200 is described below.

First, the multiple jigs 112, to which the piezoelectric transducers 111 are fixed, are arranged along the outer wall circumference of the pipe 200 at constant intervals. In this case, the jigs 112 are arranged such that one surface (i.e., the ‘bottom surface’ P112) of the piezoelectric transducers 111 fixed to the multiple jigs 112 contacts the outer wall surface of the pipe 200. For reference, the jigs 112 can be arranged along the circumference of the pipe 200 in the state that the wire 114 is inserted into the guide grooves 119 formed for the respective multiple jigs 112.

Thereafter, the multiple jigs 112 arranged along the circumference of the pipe 200 are surrounded and tightened by the wire 114 to be fixed onto the outer wall of the pipe 200. In this case, the wire 114 is fastened through operation of the wire fastening units 118 in the state that the wire 114 is sufficiently tightened.

Thereafter, the screws 113 pass through the respective multiple jigs 112 via the screw holes 117 of the jigs 112 to apply a pressure to the piezoelectric transducers 111 in the direction of the pipe 200. Accordingly, one surface (i.e., the ‘bottom surface’ P112) of the piezoelectric transducers 111 inserted into one side (i.e., the ‘open side’) of the jigs 112 closely contacts the outer wall surface of the pipe 200.

In the state that the multiple jigs 112 are arranged and fixed along the circumstance of the pipe 200, a driving voltage is applied to the piezoelectric transducers 111 so as to generate a torsional wave for each of the piezoelectric transducers 111. As described above, by providing the multiple piezoelectric transducers 111 on the circumstance of the pipe 200 by means of the jigs 112 and the wire 114, it is possible to generate a sufficient size of a torsional wave while the size of the ultrasonic wave transmission unit 110 and the method for providing the same unit is not affected by the diameter of the pipe 200.

Meanwhile, the configuration and the shape of the ultrasonic wave transmission unit 110, and the method for providing the same unit on the pipe 200 as explained with reference to FIGS. 3 and 4 correspond to the configuration and the shape of the ultrasonic wave reception unit 130 and the method for providing the same unit on the pipe 200.

However, unlike the ultrasonic wave transmission unit 110, when the piezoelectric element polarized in the circumferential direction of the pipe 200 receives vibration by the ultrasonic signal in the direction perpendicular to the polarization direction, the piezoelectric transducers of the ultrasonic wave reception unit 130 generate a corresponding voltage signal.

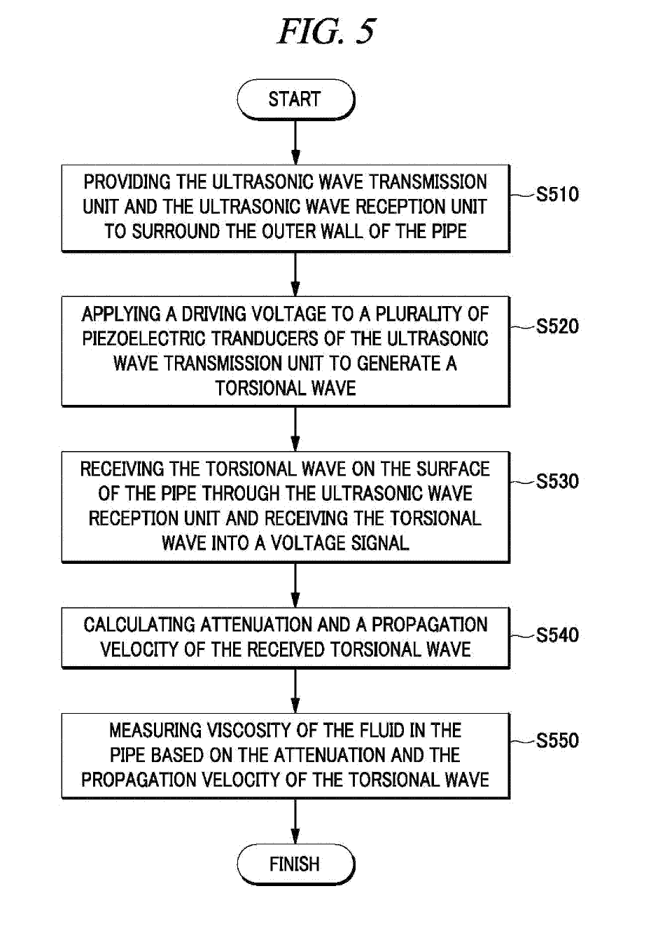

Hereinafter, an ultrasonic viscosity measuring method in accordance with an illustrative embodiment of the present disclosure is described in detail with reference to FIG. 5.

FIG. 5 is a sequence view for depiction of an ultrasonic viscosity measuring method in accordance with an illustrative embodiment of the present disclosure.

First, the ultrasonic wave transmission unit and the ultrasonic wave reception unit are provided to surround the outer wall of the pipe containing a fluid (S510).

In this case, the ultrasonic wave transmission unit and the ultrasonic wave reception unit are spaced from each other with a certain distance in the longitudinal direction of the pipe. For reference, the fluid contained in the pipe may be flowing or have filled the pipe and no longer flows.

In addition, each of the ultrasonic wave transmission unit and the ultrasonic wave reception unit includes multiple piezoelectric transducers. The piezoelectric transducers of the ultrasonic wave transmission unit are configured by a piezoelectric element for converting a voltage signal into an ultrasonic signal. The piezoelectric transducers of the ultrasonic wave reception unit are configured by a piezoelectric element for converting an ultrasonic signal into a voltage signal.

Meanwhile, as the ultrasonic wave transmission unit and the ultrasonic wave reception unit are provided on the pipe 200, the multiple piezoelectric transducers included in each of the units are arranged and fixed along the outer wall circumstance of the pipe 200 at constant intervals. Specifically, the multiple piezoelectric transducers of each of the ultrasonic wave transmission unit and the ultrasonic wave reception unit are inserted into the corresponding jigs and fixed thereto, respectively. In the state that the multiple jigs, to which the piezoelectric transducers are fixed, are arranged along the circumference to the pipe, the jigs are surrounded by the wire to be fixed to the outer wall circumference of the pipe. In this case, the piezoelectric transducers fixed to the jigs are arranged to contact the outer wall surface of the pipe. In addition, after a screw passes through the screw hole formed on one side of the jigs, a pressure is applied to the piezoelectric transducers in contact with the screw in the direction toward the pipe. Accordingly, the piezoelectric transducers fixed to the jigs more closely contact the outer wall surface of the pipe.

Thereafter, a preset driving voltage is applied to the multiple piezoelectric transducers of the ultrasonic wave transmission unit 110 provided on the pipe 200 to generate a torsional wave on the wall surface of the pipe (S520).

In this case, an AC voltage is applied as the driving voltage to the piezoelectric transducers to generate a torsional wave. In this way, by generating a torsional wave in each of the multiple piezoelectric transducers, it is possible to provide sufficient torsional waves depending on a diameter of the pipe.

Accordingly, once an ultrasonic signal (i.e., a torsional wave) is propagated along the surface of the pipe, the propagated ultrasonic signal is received through the ultrasonic wave reception unit and converted into a voltage signal (S530).

Thereafter, based on the time for generation and reception of the ultrasonic signal and a voltage value for the converted voltage signal, an attenuation and a propagation velocity of the propagated ultrasonic signal (i.e., a torsional wave) are calculated (S540).

Thereafter, viscosity of the fluid within the pipe is measured based on the calculated attenuation and propagation velocity of the ultrasonic signal (S550).

The illustrative embodiments of the present disclosure can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the illustrative embodiments of the present disclosure is provided for the purpose of illustration, and it would be understood by those skilled in the art that various changes and modifications may be made without changing technical conception and essential features of the illustrative embodiments. Thus, it is clear that the above-described illustrative embodiments are illustrative in all aspects and do not limit the present disclosure. For example, each component described to be of a single type can be implemented in a distributed manner. Likewise, components described to be distributed can be implemented in a combined manner.

In addition, the method and the system of the present disclosure have been described in relation to the certain examples. However, the components or parts or all the operations of the method and the system may be embodied using a computer system having universally used hardware architecture.

The scope of the inventive concept of the present disclosure is defined by the following claims and their equivalents rather than by the detailed description of the illustrative embodiments. It shall be understood that all modifications and embodiments conceived from the meaning and scope of the claims and their equivalents are included in the scope of the inventive concept.

### EXPLANATION OF CODES

100: Ultrasonic viscosity measuring apparatus
200: Pipe
110: Ultrasonic wave transmission unit
120: Driving unit
130: Ultrasonic wave reception unit
140: Viscosity measurement unit
111: Piezoelectric transducers
112: Jigs
113: Screws
114: Wires
115, 116: Cables
117: Screw holes
118: Wire fastening units
119: Guide grooves

What is claimed is:

1. An ultrasonic viscosity measuring apparatus for measuring viscosity of a fluid in a pipe, the apparatus comprising:
an ultrasonic wave transmission unit, in which when a preset voltage signal is applied, the voltage signal is converted into an ultrasonic signal to be propagated to a surface of the pipe;
an ultrasonic wave reception unit, in which the ultrasonic signal propagated through the surface of the pipe is received and converted into a voltage signal; and
a viscosity measurement unit, in which viscosity of the fluid in the pipe is measured based on the voltage signal converted by the ultrasonic wave reception unit,
wherein the ultrasonic wave transmission unit and the ultrasonic wave reception unit are provided on an outer wall of the pipe while being spaced from each other at a certain distance in a longitudinal direction of the pipe, and
the ultrasonic signal is a torsional wave.

2. The ultrasonic viscosity measuring apparatus of claim 1,
wherein the ultrasonic wave transmission unit comprises:
a plurality of piezoelectric transducers, in which when the voltage signal is applied, the voltage signal is converted into the torsional wave;
jigs each having a shape allowing at least part of each of the piezoelectric transducers to be inserted thereinto and corresponding to the plurality of the piezoelectric transducers; and
a wire for fixing the plurality of the jigs arranged along an outer wall circumference of the pipe at constant intervals onto the outer wall of the pipe, and
the piezoelectric transducers are inserted into the jigs, respectively, and fixed thereto.

3. The ultrasonic viscosity measuring apparatus of claim 2,
wherein the apparatus further comprises a driving unit, which applies an AC voltage as a driving voltage of the piezoelectric transducers, and
the driving voltage is applied in a direction perpendicular to a polarization direction of the piezoelectric transducers.

4. The ultrasonic viscosity measuring apparatus of claim 1,
wherein the ultrasonic wave reception unit comprises:
a plurality of piezoelectric transducers, in which when vibration of the torsional wave is received, the torsional wave is converted into the voltage signal;
jigs each having a shape allowing at least part of each of the piezoelectric transducers to be inserted thereinto and corresponding to the plurality of the piezoelectric transducers; and
a wire for fixing the plurality of the jigs arranged along the outer wall circumference of the pipe at constant intervals onto the outer wall of the pipe, and
the piezoelectric transducers are inserted into the jigs and fixed thereto.

5. The ultrasonic viscosity measuring apparatus of claim 2,
wherein the apparatus further comprises screws, which pass through screw holes formed on one side of the jigs to contact one surface of the piezoelectric transducers fixed to the jigs, and
when a pressure is applied to one surface of the piezoelectric transducers through the screws in a direction toward the pipe, the other surface of the piezoelectric transducers closely contacts the outer wall surface of the pipe.

6. The ultrasonic viscosity measuring apparatus of claim 4,
wherein the apparatus further comprises screws, which pass through screw holes formed on one side of the jigs to contact one surface of the piezoelectric transducers fixed to the jigs, and
when a pressure is applied to one surface of the piezoelectric transducers through the screws in a direction toward the pipe, the other surface of the piezoelectric transducers closely contacts the outer wall surface of the pipe.

7. The ultrasonic viscosity measuring apparatus of claim 1,
wherein the viscosity measurement unit measures viscosity of the fluid based on time required for the torsional wave generated from the ultrasonic wave transmission unit to reach the ultrasonic wave reception unit, and a voltage of the voltage signal converted from the ultrasonic wave reception unit.

8. An ultrasonic viscosity measuring method for measuring viscosity of a fluid in a pipe through an ultrasonic viscosity measuring apparatus, the method comprising:
(a) applying a driving voltage to a plurality of first piezoelectric transducers provided along an outer wall circumference of the pipe at constant intervals to generate a torsional wave on a surface of the pipe;
(b) receiving the torsional wave propagated along the surface of the pipe through a plurality of second piezoelectric transducers provided along the outer wall circumference of the pipe at constant intervals while being spaced from the first piezoelectric transducers at a certain distance in a longitudinal direction of the pipe to convert the torsional wave into a voltage signal;
(c) calculating an attenuation and a propagation velocity of the torsional wave based on the time for the propagation of the torsional wave and the converted voltage signal; and
(d) measuring viscosity of the fluid in the pipe based on the calculated attenuation and propagation velocity of the torsional wave.

9. The ultrasonic viscosity measuring method of claim 8,
wherein the step (a) applies an AC voltage in a direction perpendicular to a polarization direction of the first piezoelectric transducers.

10. The ultrasonic viscosity measuring method of claim 8,
wherein the plurality of the first and second piezoelectric transducers are inserted into jigs and fixed thereto,
a plurality of first jigs, to which the first piezoelectric transducers are fixed, are fixed to an outer wall circumference of the pipe via a first wire, and a plurality of second jigs, to which the second piezoelectric transducers are fixed, are fixed to the outer wall circumference of the pipe via a second wire, and
the first and second piezoelectric transducers contact the outer wall surface of the pipe.

11. The ultrasonic viscosity measuring method of claim 8,
wherein the first and second piezoelectric transducers closely contact the outer wall of the pipe in the manner that a pressure is applied in a direction toward the pipe through screws passing through the jigs via screw holes formed on one side of the jigs to contact the pipe.
